(19) United States
(12) Patent Application Publication
(10) Pub. No.: US 2026/0291814 A1
(43) Pub. Date: Sep. 24, 2026

(54) PASSIVE INDUSTRIAL NETWORK TOPOLOGY GENERATION USING EVENT LOGS

(71) Applicant: Rockwell Automation Technologies, Inc., Mayfield Heights, OH (US)

(72) Inventor: James R. Copus, Fairlawn, OH (US)

(21) Appl. No.: 19/087,228

(22) Filed: Mar. 21, 2025

(51) Int. Cl. H04L 41/12; H04L 9/40; H04L 67/12

(52) U.S. Cl. CPC H04L 41/12; H04L 63/1416; H04L 67/12

(57) ABSTRACT

The disclosure describes a network topology service that generates and maintains industrial network topologies based on passively obtained event logs. The event logs are generated by various devices in an industrial automation environment and collected and stored by a collector. The network topology service retrieves the event logs from the collector and analyzes the event logs to make inferences about the network topology. The network topology service generates and updates the network topology based on these inferences.

### BACKGROUND

Industrial systems often include a range of interconnected devices, including, for example, programmable logic controllers (PLCs), network adapters, switches, workstations (e.g., on which users perform design, programming, and update functions), among various other types of devices. Administrators may utilize a network topology representing the layout of the industrial system, including the network addresses and types of devices, as well as how the devices are connected. This network topology may be useful for various tasks, including, for example, troubleshooting network issues, optimizing performance, or identifying potential security issues. However, maintaining an accurate network topology can be a complex and time-consuming process, particularly in systems with a large number of devices, diverse communication protocols, and frequent configuration changes.

A network topology can quickly become outdated as new devices are added, removed, or reconfigured within the industrial system. Network administrators may manually update the topology upon discovering changes, but this process is prone to delays and inaccuracies, particularly in environments where network operations and plant operations are managed by separate teams. Communication gaps between plant operators and network administrators can lead to inaccurate or incomplete device records, leading to inconsistencies in the topology.

Another approach is to actively scan the network to detect changes, such as by sending queries to devices in the network. However, the active scanning process may include processing multiple types of network and system data, such as security policy settings, and protocol-specific responses from industrial devices. This increases the complexity of both scanning tools and the configurations utilized by administrators, making it difficult to scale in large industrial environments. Accordingly, improvements are needed.

### SUMMARY

The disclosure describes a network topology service that generates and maintains network topologies based on passively obtained event logs generated in an industrial automation environment. As various devices in the industrial automation environment generate event logs, a collector obtains and stores these event logs. The network topology service retrieves the event logs from the collector and analyzes them to make inferences and update the network topology. Accordingly, the network topology service generates a network topology without the use of active scanning, alleviating the above-described issues.

One example of a computer-implemented method performed according to some implementations includes obtaining an event log from a device in an industrial automation environment. The method further includes analyzing the event log to make an inference about a network topology of the industrial automation environment. The network topology defines one or more parameters of multiple devices in the industrial automation environment, and communication links between the devices. The method further includes updating the network topology to incorporate the inference.

In some implementations, the event log includes a source address of a communication in the network, a target address of the communication, and an event description of the communication. The device is associated with the target address.

In some implementations, analyzing the event log includes inferring a device type of the device based at least on the event description.

In some implementations, analyzing the event log includes inferring a new communication link, in the network, between the device and a second device based at least in part on the source address of the communication.

In some implementations, the method further includes analyzing one or more additional event logs from a second device in the industrial automation environment to assign each of the plurality of devices to a network security zone. The method may further include detecting a security threat based at least in part on a comparison between the network topology and the assigned network security zones.

In some implementations, identifying the security threat includes identifying, within the network topology, a communication link between two devices, from the plurality of devices, assigned to different network security zones.

In some implementations, the method further includes generating a graphical representation of the network topology. The method may further include transmitting the graphical representation to a user device for display in a user interface.

These and other features and aspects of various examples may be understood in view of the following detailed discussion and accompanying drawings.

### BRIEF DESCRIPTION OF THE DRAWINGS

FIG. 1 illustrates an industrial automation environment in an implementation.

FIG. 2 illustrates another view of the industrial automation environment in an implementation.

FIG. 3 illustrates an event-log parsing sequence in an implementation.

FIG. 4 illustrates an industrial network topology in an implementation.

FIG. 5A-5C illustrate inference sequences in implementations.

FIG. 6 illustrates another event-log parsing sequence in an implementation.

FIG. 7 illustrates a user interface in an implementation.

FIG. 8 represents a topology generation process in an implementation.

FIG. 9 illustrates a computing system suitable for implementing the various operational environments, architectures, processes, scenarios, sequences, and frameworks discussed below with respect to the other Figures.

### DETAILED DESCRIPTION

In industrial automation environments, network administrators rely on industrial network topologies for various tasks such as troubleshooting, design updates, and security assessments. These topologies provide detailed information about the devices within the network, including device types (e.g., Programmable Logic Controllers (PLCs), network adapters, workstations, and input/output (I/O) modules), communication connections between devices, and other parameters like IP addresses or slot assignments. However, creating and maintaining these topologies is a complex and resource-intensive process, especially in environments with many devices. Such environments often experience frequent changes, such as devices being added, removed, or relocated, or network configurations being updated (e.g., IP address assignments or backplane reconfigurations), which complicates the maintenance of industrial network topologies.

Existing options include severe limitations. For example, administrators may manually create and maintain these topologies using detailed configuration files or project data for devices such as PLCs. However, this approach is labor-intensive and error-prone, especially in dynamic environments where devices are frequently added, removed, or relocated, or where network configurations (e.g., IP address changes or backplane reconfigurations) are updated. As another example, an administrator may utilize an active scanning tool (e.g., a network discovery tool like Nmap) to probe devices, including PLCs, network adapters, and workstations, for their presence, types, and connections. This approach generates significant network traffic, potentially disrupting real-time operations of PLCs, network adapters, and other devices. Active scanning techniques often involve installing additional software agents on industrial devices to collect and transmit data, adding complexity to system configuration and management. Moreover, industrial automation environments often feature multiple interconnected networks with diverse communication paths. For instance, an environment might include an Ethernet network that connects PLCs, workstations, and network adapters across a facility, while devices within a chassis (e.g., PLCs, network adapters, and I/O modules) may communicate with one another via a backplane. A device connected to a backplane of a chassis may not be discoverable by active techniques if the device does not have an IP address in the network.

To address these issues, described herein is a network topology service that generates and updates an industrial network topology based on passively obtained event logs. Accordingly, the network topology service generates and maintains the industrial network topology without active scanning or laborious manual processes, alleviating the above-described issues.

Many devices in an industrial automation environment with network connectivity, such as PLCs, network adapters, network switches, and workstations, are pre-configured to generate event logs helping ensure the event log collection does not add to the complexity or resource usage of the system. These event logs may include network event logs, such as Syslog messages generated by industrial devices, which record device communications, configuration changes, and status updates. The logs may also include system event logs, such as Windows Event Viewer logs generated by workstations, which capture status events associated with industrial devices in the industrial automation environment. These event logs are generally used for operational tracking and security auditing, providing a historical record of system activity. The network topology service described herein uses these existing logs to infer relationships between devices and generate an up-to-date representation of the industrial network topology, providing topology updates without active network scanning or manual processes.

For example, an event log generated by a PLC may include an entry for a communication received by the PLC. The entry may include an IP address for the source of a communication, an IP address for the target of the communication (i.e., the PLC itself), and a description of the communication event (e.g., a firmware update). Based on this information, the network topology service may infer that the source IP address belongs to a workstation running firmware update software (e.g., ControlFLASH Plus by Rockwell Automation, among other examples), since firmware updates are typically initiated from such workstations rather than from other PLCs or network devices. In some implementations, the network topology service may make inferences (e.g., inferring the type of device) based on a single event log. In other implementations, the network topology service may employ a threshold-based approach (e.g., making an inference about device-type only after a threshold number of communications support the inference) to reduce false positives and thus improve the accuracy of the network topology.

The generated network topology captures detailed information about industrial devices within the automation system, including communication links between devices, as well as descriptive metadata such as IP addresses, slot numbers in a chassis, serial numbers, and device types. The network topology service continuously refines and updates this topology based on event logs, allowing it to infer the presence of devices and dynamically enhance their metadata as additional data becomes available.

For example, an event log may indicate that a communication originated from “Slot 2” of a chassis, prompting the network topology service to add a new device entry labeled “Slot 2” in the topology. As subsequent logs are received, the network topology service may identify additional attributes of the Slot 2 device. For instance, a subsequent event log might contain a network reconfiguration event, indicating that Slot 2 is a network adapter routing a request from a user. Upon recognizing this pattern, the network topology service updates the metadata of the Slot 2 device, refining its classification from “unknown” to “network adapter.”

Network administrators and software services may utilize the network topology to perform various security and management functions, including identifying vulnerabilities, detecting security breaches, and updating network configurations. For example, the network topology service may overlay the network topology with security zone classifications identifying IP addresses with security zones. These zone classifications may be inferred from event logs, such as Windows Event Viewer logs, as described further herein. By analyzing the zone classifications in view of the network topology, the network topology service can analyze communication links across different security zones. If a device in one zone is found with a communication link (in the network topology) to a device with another zone, this may indicate a potential security breach.

By leveraging event logs, the network topology service generates and maintains an accurate representation of the network using existing logging mechanisms. Unlike traditional active scanning tools, which periodically probe devices and consume processing power, this approach reduces the need for network scans, thereby reducing network overhead. Further, the use of existing logging mechanism provides for network topologies without installing additional software agents on industrial devices. The described network topology service may improve the efficient usage of computing resources. For example, since event log collection is a pre-existing component of many industrial automation environments, the network topology service can passively infer device relationships and network structures without adding computational strain on industrial controllers, workstations, or network infrastructure. Unlike active scans that require processing responses from multiple devices, the topology service parses existing logs, thus reducing CPU and memory consumption.

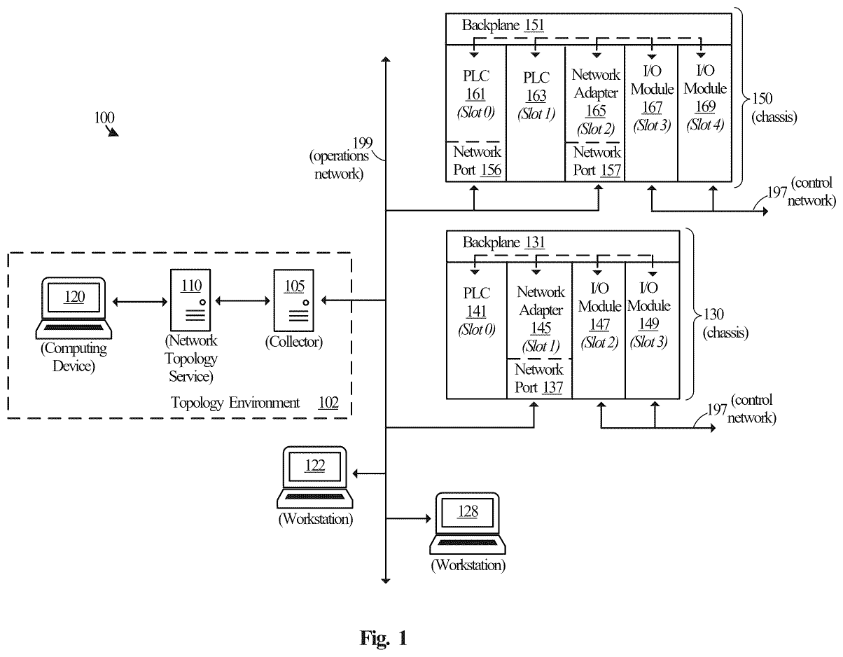

FIG. 1 illustrates industrial automation environment 100 in an implementation. Industrial automation environment 100 includes topology environment 102, chassis 130, 150, workstations 122, 128, control network 197, and operations network 199. Topology environment 102 includes collector 105, network topology service 110, and computing device 120. It is noted that while certain elements are illustrated in FIG. 1, industrial automation environment 100 may include different or additional components not shown in FIG. 1 for clarity.

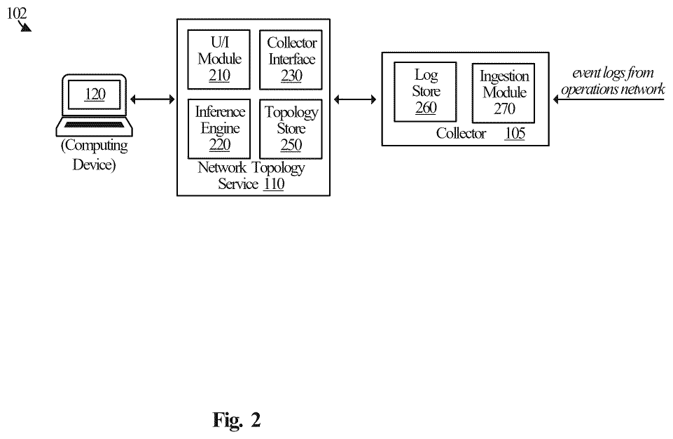

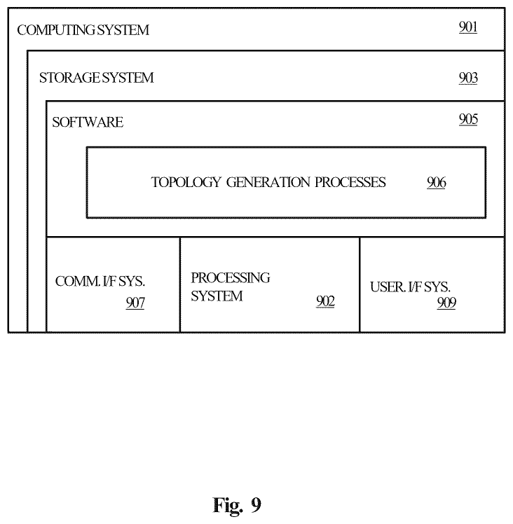

Collector 105 is representative of a software-based service that collects and stores event logs from devices (e.g., PLCs 161, 163, network adapter 165, etc.) from industrial automation environment 100. Collector 105 may include a data repository (e.g., log store 260 of FIG. 2) which may include persistent storage in which the event logs are maintained. Collector 105 may be implemented on one or more servers, which may be represented by computing system 901 of FIG. 9.

Network topology service 110 is representative of a software-based service for passively generating an industrial network topology. Network topology service 110 may be implemented on one or more servers (which may be represented by computing system 901 of FIG. 9), according to some implementations. In other implementations, network topology service 110 may be a cloud-based service. In some embodiments, computing devices serving network topology service 110 may be connected to operations network 199.

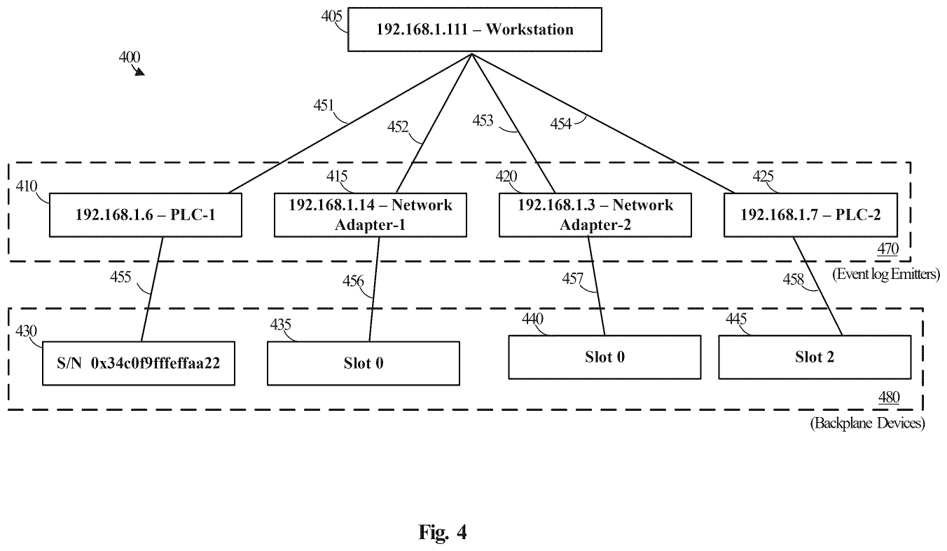

Network topology service 110 obtains event logs from collector 105 and parses the event logs to generate and maintain industrial network topologies. For example, if a device in industrial automation environment 100 frequently sends firmware updates, network topology service 110 may infer that the device is a workstation (e.g., workstation 122 or 128) employing firmware-update software, and update the network topology accordingly. Network topology service 110 may utilize a rules-based engine (e.g., utilizing logic rules such as if-then logic or decision trees) to perform these inferences, according to some implementations. An example network topology generated by network topology service 110 is illustrated by topology 400 of FIG. 4.

Industrial automation environment 100 may utilize a standardized log format, such as Syslog, which facilitates efficient processing by network topology service 110. Syslog is an event logging format that allows networked devices to generate structured log messages for operational monitoring, diagnostics, and security auditing. Syslog messages in industrial automation environment 100 may be generated by PLCs 161, network adapters 145, 165, network switches, and other networked devices. Syslog messages typically contain timestamped records of system activity, including device communications, configuration changes, authentication attempts, and error conditions. Network topology service 110 can leverage the structured nature of Syslog messages to make inferences about the industrial automation environment.

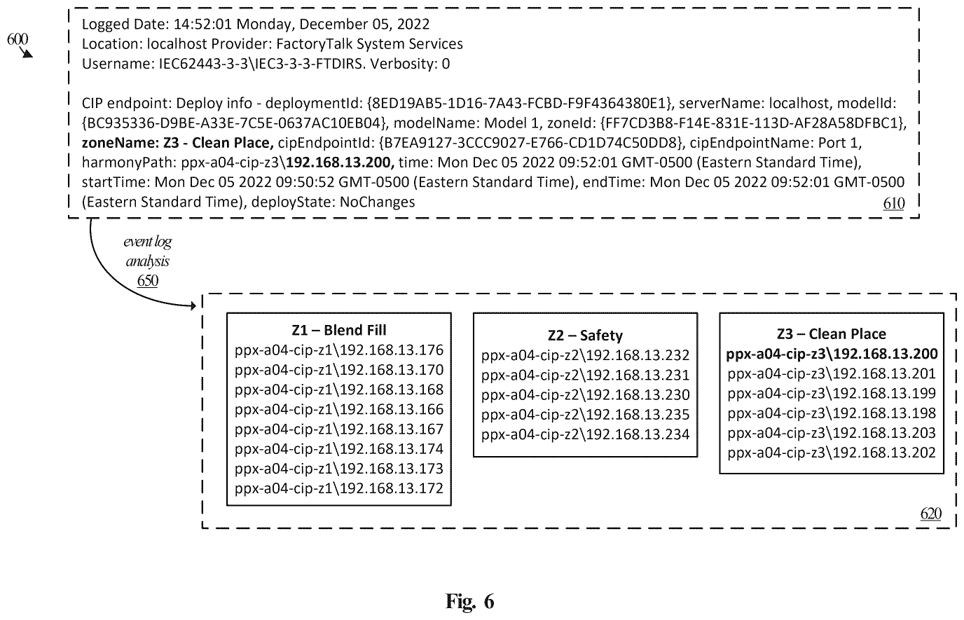

In addition to Syslog messages, network topology service 110 may process Windows Event Viewer logs, which may be generated by workstations 122, 128. Windows Event Viewer logs provide detailed records of system activity on Windows-based computing devices, including security events, administrative actions, software installations, user authentication attempts, and network configuration changes. Industrial applications running on workstations 122, 128 may generate such event logs (e.g., event log 610 of FIG. 6) including information about devices in industrial automation environment 100. Network topology service 110 may utilize these Windows Event Viewer logs to generate zone topologies, as illustrated for example in FIG. 6. Accordingly, network topology service 110 may process and make inferences based on diverse log formats. While Syslog and Windows Event Viewer logs are described here for illustrative purposes, it is noted that a variety of other types of logs may be utilized without departing from the spirit and scope of the disclosure.

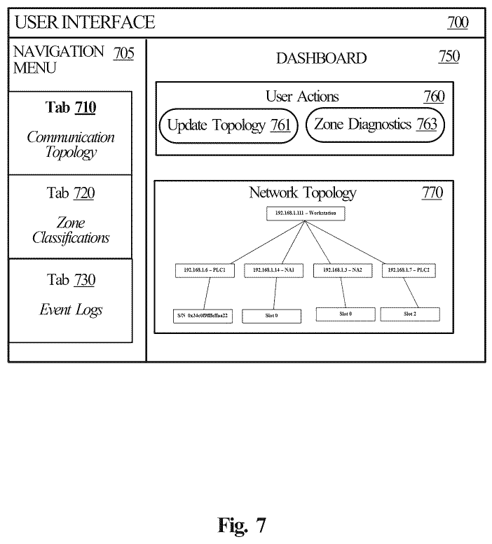

Computing device 120 is a device on which a user or administrator may interact with network topology service 110. Computing device 120 may be a laptop, personal computer, tablet, mobile device, or a similar device. Network topology service 110 may provide computing device 120 with a user interface via which the user can interact with network topology service 110 (as represented for example by user interface 700 of FIG. 7). Via this user interface, the user may view event logs (e.g., by selecting tab 730 in user interface 700 of FIG. 7), view the network topology (e.g., by selecting tab 710 of user interface 700) and run diagnostics (e.g., by selecting element 763 of user interface 700). Computing device 120 may be represented by computing system 901 of FIG. 9. In some embodiments, computing device 120 may be connected to operations network 199.

Operations network 199 represents a network of industrial devices that communicate over Ethernet or other industrial networking protocols. For example, workstations 122, 128 may communicate with various devices in the network, such as PLC 161 and network device 165, to perform tasks such as updating device configurations, applying firmware updates, and modifying control logic. Devices within operations network 199 include PLC 161, network device 165, workstations 122, 128, and other devices such as network adaptors, each of which may generate event logs and provide them to collector 105. These event logs are utilized by network topology service 110 to make inferences about the network topology. It is noted that the devices depicted in FIG. 1 are for illustrative purposes, and operations network 199 may include additional devices not explicitly shown for clarity. Event logs may identify various events occurring within operations network. For example, an event log may capture a communication between two devices (e.g., a communication from network adapter 165 to PLC 161). An event log may be generated by a source device of a communication (e.g., network adapter 165), a target device of the communication (e.g., PLC 161)or a different device such as workstation 122 or a network switch obtaining information about the communication.

Chassis 150 is a slot-based enclosure that houses industrial devices, including PLCs 161 and 163, network adapter 165, and I/O modules 167 and 169. Chassis 150 may be, for example, a 1756 ControlLogix chassis, which provides a modular framework for industrial automation components. Chassis 150 includes backplane 151, which provides communication between devices within chassis 150. Backplane 151 may include high-speed buses providing direct communications between devices in chassis 150. Communications in backplane 151 are isolated from operations network 199, meaning data exchanged between devices within the chassis does not traverse operations network 199. For example, network adapter 165 may communicate with PLCs 161 and 163 to update network configurations or facilitate external network communication. Similarly, PLCs 161 and 163 may send outputs to devices such as motor controllers and receive inputs from I/O modules 167, 169 via backplane 151.

Devices within chassis 150 may generate event logs that document communications received via backplane 151. These event logs may indicate the source of a communication using a slot number (e.g., “slot 0’), which network topology service 110 utilizes to infer the presence of a device in that slot. For example, if an event log generated by PLC 161 records a communication received from “Slot 2,” network topology service 110 may infer the existence of a device installed in Slot 2 that is actively communicating with PLC 161. As additional logs are analyzed, the system may further refine the network topology, such as determining that Slot 2 contains a network adapter.

Programmable Logic Controllers (PLCs) 161, 163 are industrial controllers (e.g., ControlLogix controllers, among other examples) that execute control functions within an industrial automation environment. PLCs 161, 163 receive input data, such as sensor signals, and generate control commands to regulate industrial processes. PLCs 161, 163 communicate over control network 197, transmitting control commands to actuators, motor drives, and other field devices via I/O modules 167, 169.

While some PLCs can communicate over operations network 199, others may lack this capability. In the example illustrated in FIG. 1, PLC 161 includes network port 156, allowing it to directly communicate over operations network 199. Network port 156 of PLC 161 may represent a port for connecting to operations network 199, such as an Ethernet port receiving an Ethernet cable. In some implementations, network port 156 of PLC 161 may be associated with a particular IP address in operations network 199. Network port 156 allows PLC 161 to provide event logs (e.g., Syslog messages) to collector 105. In contrast, PLC 163 may not have a dedicated IP address within operations network 199 but can be inferred in the network topology through event logs generated by networked devices like PLC 161 or network adapter 165, which reference its backplane slot (e.g., Slot 1). Accordingly, network topology service 110 may connection links with devices (such as PLC 163) that are not directly connected to operations network 199.

For example, an Ethernet-enabled PLC (represented by PLC 161) includes built-in Ethernet capabilities, allowing it to directly integrate with operations network 199. In contrast, PLC 163 may be an older PLC model that lacks native Ethernet support and instead relies on network adapter 165 to communicate with operations network 199. In this example, PLC 161 may function as an event log emitter, generating Syslog messages and transmitting them to collector 105 (e.g., one of the event log emitters 470 in topology 400 of FIG. 4). However, PLC 163, which does not have a direct connection to operations network 199, may appear in the network topology only as a backplane device (e.g., backplane device 480 in FIG. 4).

Despite the lack of a direct network presence for PLC 163, network topology service 110 may infer its existence based on event logs generated by other devices. For instance, an event log generated by PLC 161 may reference “Slot 1” in relation to PLC 163 (to capture a communication over backplane 151), enabling network topology service 110 to identify a communication link between PLC 161 and PLC 163. In this case, the reference to “Slot 1” provides evidence of PLC 163, even though PLC 163 itself does not generate event logs for collector 105.

Network adapter 165 represents an industrial network interface module that facilitates communication between devices within chassis 150 and external networks, such as operations network 199. Network adapter 165 may be, for example, a 1756-EN4TR EtherNet/IP module or a similar network interface device, among other examples. Network adapter 165 provides a bridge between backplane communications and operations network 199, allowing devices within chassis 150, such as PLCs 161 and 163 and I/O modules 167 and 169, to exchange data over operations network 199. This provides a path for workstations 122, 128 and other systems in operations network 199 configure other devices in chassis 150 (e.g., PLCs, 161, 163, etc.), upload firmware updates, or retrieve diagnostic data from these devices. Network adapter 165 is configured to generate event logs that reference communications from devices within the chassis. Since some PLCs, such as PLC 163, may lack direct Ethernet connectivity (as described above), event logs generated by network adapter 165 can provide indirect visibility into these devices by including references to specific backplane slots (e.g., “slot 1”). Network topology service 110 uses these references to infer the presence of a device in slot 1 (i.e., PLC 163) and map it within the network topology. Network adapter 165 includes network port 157, which represents a port for connecting to operations network 199 (e.g., an Ethernet port receiving an Ethernet cable). In some implementations, network port 157 may be associated with a particular IP address in operations network 199. Network port 157 allows network adapter 165 to provide event logs (e.g., Syslog messages) to collector 105.

I/O modules 167, 169 represent communications devices that facilitate data exchange between PLCs 161, 163 and control network 197, enabling communication with external field devices such as sensors, actuators, and motor drives. I/O modules 167, 169 serve as interfaces that convert signals between PLCs 161, 163 and controlled devices such as motor drives. In one example, I/O module 167 may be an analog I/O module, designed for processing variable analog signals such as temperature, pressure, or flow sensor readings, while I/O module 169 may be a digital I/O module, responsible for handling discrete on/off signals used in applications such as switch activations, relay control, or binary sensor inputs. PLCs 161, network adapter 165, or other networked devices may generate event logs capturing interactions with I/O modules 167, 169, including status changes, command execution, configuration updates, and error reports. For instance, if PLC 161 sends a control signal to an actuator via I/O module 167, PLC 161 may generate an event log (e.g., a Syslog message) referencing Slot 3. Network topology service 110 can analyze this log to infer the existence of an I/O module in slot 3, and include the I/O module in the network topology.

Chassis 130 represents another chassis in industrial automation environment 100. Chassis 130 may be substantially similar to chassis 150, with a difference in that chassis 130 is illustrated with a different set of devices in four slots (slot 0-slot 3). Specifically, chassis 130 houses PLC 141, network adapter 145, and I/O modules 147, 149.

PLC 141 may be substantially similar to PLC 163 of chassis 150; specifically, PLC 141 may be a model of PLC that does not directly interface with operations network 199 (e.g., PLC 141 may not have ethernet capabilities). Likewise, network adapter 145 may be substantially similar to network adapter 165, and may interface with operations network over network port 137, which is substantially similar to network port 157. Likewise, I/O modules 147, 149 may be substantially similar to I/O modules 167, 169.

Workstations 122, 128 represent devices used by operational administrators to configure and maintain operations of devices in the industrial automation environment. Workstations may be provisioned with software services to perform various functions to configure, program, and maintain devices in operations network 199, such as PLCs and network adapters (e.g., using Studio 5000 Logix Designer or ControlFLASH Plus by Rockwell Automation, among other examples). Workstations 122, 128 may be laptops, personal computers, tablets, mobile devices, or similar devices. Workstations 122, 128 may be represented by computing system 901 of FIG. 9. Workstations 122, 128 may also generate event logs, such as Windows Event Viewer logs or Syslog messages, which are used by the network topology service to infer device parameters and connection links in the industrial network topology.

Workstations 122, 128 may passively generate event logs and provide these logs to collector 105. In some implementations, event logs generated by workstations 122, 128 may document interactions with devices like PLCs and network adapters, using different formats and logging systems (e.g., Windows Event Viewer logs) compared to other devices in operations network 199 (utilizing Syslog messages) and provide these logs to collector 105. However, in other implementations, workstations 122, 128 may generate the logs in the same format (e.g., Syslog messages) or, as part of logging integration, convert logs from Windows Event Viewer logs to Syslog messages. Event logs from workstations 122, 128 may be used by network topology service 110 to passively generate a zone topology, as illustrated and explained further in FIG. 6 below.

FIG. 2 illustrates a detailed view of topology environment 102 in an implementation. Topology environment 102 includes network topology service 110, collector 105, and computing device 120.

Collector 105, as previously described, is a software-based service responsible for collecting event logs from devices within operations network 199 (as illustrated in FIG. 1). Collector 105 consists of ingestion module 270 and log store 260, which work together to process and store event logs. While these modules and elements are depicted to describe the event-log collection processes described herein, the functionalities described may be incorporated into more or fewer components, software components, hardware components, firmware components, or a combination without departing from the scope and spirit of the present disclosure.

Ingestion module 270 is a software-based service that processes and stores event logs collected from operations network 199. Operations performed by ingestion module 270 may include pre-processing event logs before storing them in log store 260, which can involve identifying log types (e.g., determining whether a log is a Syslog message or a Windows Event Viewer log) and categorizing them accordingly.

Log store 260 is a data repository that retains processed event logs received from ingestion module 270. Log store 260 may be structured to store different types of logs separately, such as Syslog messages and Windows Event Viewer logs, providing for efficient indexing and retrieval. Depending on implementation, log store 260 may support structured storage formats, such as relational databases, time-series databases, or distributed data storage solutions. Depending on the implementation, log store 260 may reside in the persistent storage of a server (as represented by computing system 901 of FIG. 9) or be hosted in a cloud-based storage service.

Network topology service 110 represents a software-based service for generating and maintaining network topologies based on event logs obtained from operations network 199 (via collector 105). Network topology service 110 includes U/I module 210, inference engine 220, collector interface 230, and topology store 250. While these modules and elements are depicted to describe the event-log collection processes described herein, the functionalities described may be incorporated into more or fewer components, software components, hardware components, firmware components, or a combination without departing from the scope and spirit of the present disclosure.

Collector interface 230 represents a service for interfacing with collector 105 and retrieving event logs from collector 105, specifically from log store 260. Collector interface 230 may continuously monitor log store 260 and automatically retrieve newly added event logs for processing.

Inference engine 220 represents a service for generating and maintaining a network topology based on the event logs. Inference engine 220 receives event logs from collector 105 via collector interface 230 and processes the event logs using various inference techniques. In one implementation, inference engine 220 employs rules-based algorithms, such as if-then statements and decision trees, to make inferences about the network topology.

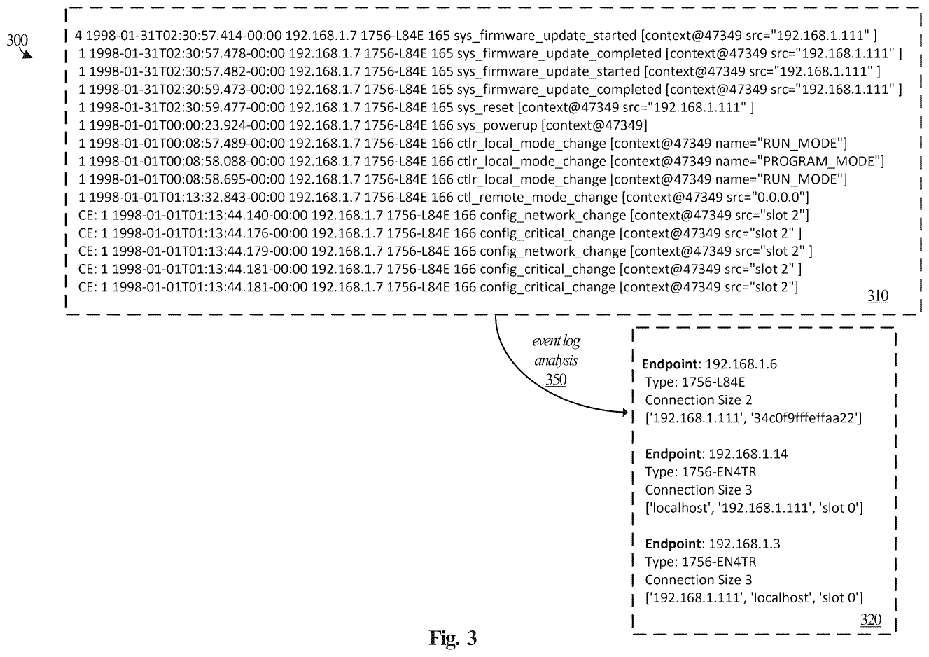

For example, inference engine 220 may analyze an event log indicating a communication between two devices, where the event description identifies the communication as a firmware update. Since firmware updates typically originate from workstations running firmware update software, inference engine 220 may infer that the source of the communication is a workstation (e.g., workstation 122 or 128 of FIG. 1). Inference engine 220 stores the inferences as metadata within the industrial network topology stored in topology store 250 (see metadata 320 of FIG. 3 for an example).

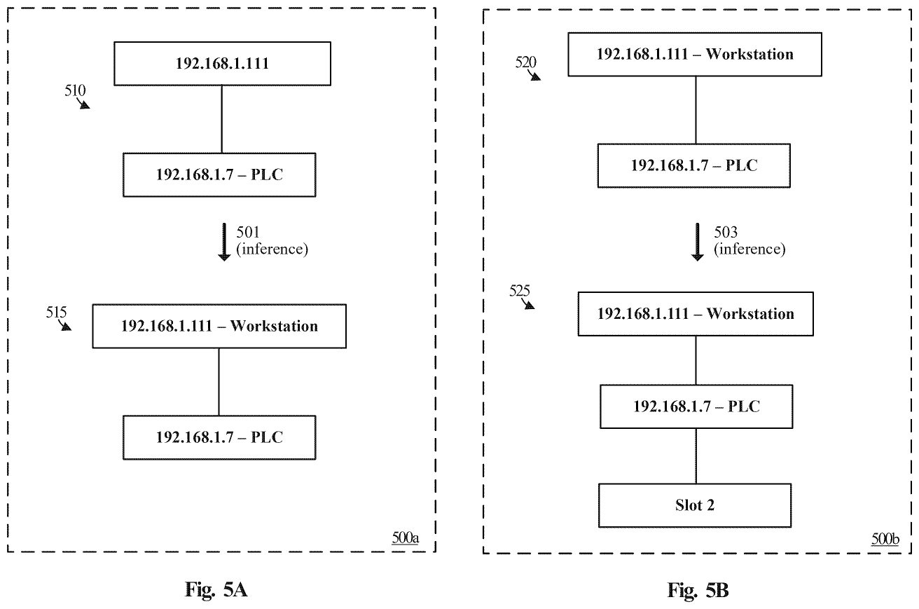

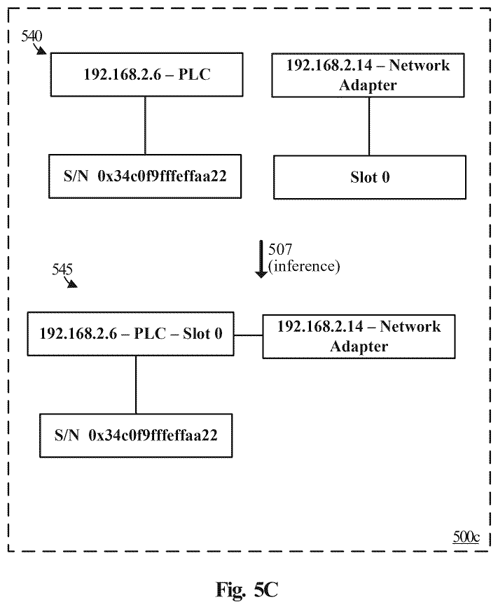

Various types of inferences made by inference engine 220 based on event logs may include, but are not limited to: identifying device types based on communication patterns, inferring the presence of new devices in industrial automation environment 100, recognizing that multiple identifiers (e.g., IP addresses, slot numbers, or serial numbers) belong to the same device, establishing a new communication link between devices, “fusing” device indicators (e.g., IP addresses, serial numbers (S/N), chassis slot numbers, etc.) to identify that the indicators refer to the same device among other examples. Various examples of inferences are described below in relation to FIG. 5A-5C.

Topology store 250 serves as the data repository for storing parameters and communication links that define the industrial network topology, including the inferences generated by inference engine 220. This metadata provides an up-to-date representation of the network, incorporating device parameters and device connections, as illustrated in metadata 320 of FIG. 3.

U/I module 210 is a service for providing a user interface for interacting with the network topology service. U/I module 210 provides the user interface to computing devices such as computing device 120. The user interface allows network administrators and other users to visualize and analyze the generated network topology. An example of the user interface provided by U/I module 210 is illustrated in FIG. 7 (user interface 700). The user interface may display a graphical representation of the industrial network topology (e.g., element 770 of FIG. 7) to allow users to view network structure, inspect inferred relationships, and detect potential security or configuration issues. Additionally, U/I module 210 may facilitate user interactions such as requesting topology updates, filtering specific device types, or viewing event logs.

FIG. 3 illustrates inference scenario 300 in an implementation. Inference scenario 300 includes event logs 310, event log analysis 350, and topology metadata 320, each of which is described in turn below.

Event logs 310 represent event logs collected from operations network 199 of FIG. 1. In this particular example, event logs 310 represent Syslog messages collected from a PLC (e.g., PLC 161 of FIG. 1). Each row of event logs 310 represents and individual event log generated by an industrial device such as PLC 161. Event logs 310 may be collected and stored by collector 105 and retrieved by network topology service 110, as described above. It is noted that the device models, operations, and other elements referenced in event logs 310 are provided by way of example for illustrative purposes. Event logs 310 may include a wide range of device models, operations, and other elements without departing from the spirit and scope of this disclosure.

Each of event logs 310 utilizes common formatting. For example, event logs 310 may begin with a timestamp including a time and date the log was generated. Taking for example the top event log of event logs 310, the timestamp is “1998-01-31T02:30:57.414-00:00.” The time stamp may be followed by an IP address of the device generating the event log (in this case, 192.168.1.7). The event log may indicate the device-type of the device (in this case, 1756-L84E, which is a model of PLC). As such, network topology service 110 may identify the device-type of the log-generating device by simply referencing this field of the event log. However, it is noted that the event logs may not necessarily reference the device type of other devices referenced in the Syslog message (e.g., the source of a communication referenced in the event log). In these cases, network topology service 110 may employ other techniques to infer device types, as discussed below. Following the device type, the event log may include a description and context of an event (in this case “sys_firmware_update_started: [context@47349 src=“192.168.1.111”].” This log entry indicates that a device with the IP address 192.168.1.111 initiated a firmware update on the log-generating device. Based on this information, network topology service 110 may infer that the device with IP address 192.168.1.111 is a workstation, since workstations running firmware update software are typically responsible for initiating firmware updates on PLCs and other industrial devices.

As another example, in the last of event logs 310, the description of the event is “config_critical_change [context@47349 src=“slot 2”]. This log entry indicates that the device generating the log received a “config_critical_change” event originating from “slot 2.” In this context, “slot 2” refers to a specific slot within a chassis (such as chassis 130, 150 of FIG. 1), meaning that the log-generating device has received a critical configuration update from a device installed in slot 2 via a backplane of the chassis (e.g., backplane 131, 151 of FIG. 1).

Based on this event log, network topology service 110 may infer that the log-generating device is communicating with a device located in slot 2 of a chassis via the chassis backplane. Since backplane communications are localized within the chassis (e.g., chassis 130, 150 of FIG. 1), this inference provides insight into backplane relationships that may not be captured through traditional network scanning techniques.

Event log analysis 350 illustrates analysis of event logs 310 performed by network topology service 110 (and in particular, inference engine 220). Inference engine 220 analyzes event logs 310 to make inferences about device types, communication links, among various other types of inferences described herein. Inferences made by inference engine 220 are stored in topology store 250 (see FIG. 2) as metadata, as represented by metadata 320 of FIG. 2.

Metadata 320 illustrates an example of metadata defining a network topology, including inferences made by inference engine 220 during event log analysis 350. Metadata 320 contains parameters of the topology in relation to three different devices as an example of how network topology information is structured. Parameters include the “Endpoint” field represents the IP address of an identified device, allowing the network topology service 110 to track networked devices by their addresses. The “Type” field specifies the type of industrial device associated with the endpoint, such as “1756-L84E,” which identifies the device as a model of PLC set forth in event logs 310. Additionally, metadata 320 contains a “Connection Size” field, which indicates the number of connection links between the device and other identified devices in the network topology. Metadata 320 also includes a list of devices that have communicated with the identified device. For example, metadata 320 may indicate: [‘192.168.1.111’, ‘34c0f9fffeffaa22’]. This entry reveals that the device has communicated with two other devices: one identified by an IP address (192.168.1.111) and another identified by a serial number (34c0f9fffeffaa22); representative of communication links between Endpoint 192.168.1.6 and the identified devices. This demonstrates the ability of network topology service 110 to correlate multiple device identifiers, including IP addresses, and serial numbers (as well as other identifiers such as backplane slot identifiers), to construct a comprehensive description of the industrial network topology. In general, parameters in metadata 320 defining the network topology may include device types associated with the devices, network addresses for the devices, serial numbers of the devices, and chassis slot numbers for the devices, among other parameters.

FIG. 4 illustrates a graphical representation of topology 400. Such a graphical representation may be constructed based on topology metadata, such as metadata 320 of FIG. 3. For example, U/I module 210 may generate the graphical representation based on the metadata and display it in a user interface (as represented by element 770 of user interface 700 in FIG. 7).

Topology 400 includes devices 405, 410, 415, 420, 425, 430, 435, 440, 445 (referred to collectively as devices 405-445) and communication links 451, 452, 453, 454, 455, 456, 457, 458 (referred to collectively by communication links 451-458).

Each of devices 405-445 may be associated with various device identifiers depending on the respective inferences made by network topology service 110. For example, for device 405, network topology service 110 may have identified the IP address (in this case 192.168.1.111) and inferred that the device is a workstation (e.g., workstation 122 or 128 of FIG. 1). Thus device 405 is associated with two identifiers: the IP address and the device type (“Workstation”). By contrast, device 435 only includes one identifier (“Slot 0”). The existence of device 435 is inferred by network topology service 110 based, for example on an event log indicating “Slot 0” as the source of a communication (indicating a communication received via a backplane of a chassis, such as backplane 151 of chassis 150 of FIG. 1). Since backplane communications do not involve IP-address-based networking, network topology service 110 does not initially associate an IP address with device 435. However, as additional event logs are processed, network topology service 110 may be able to extract further identifiers for device 435, such as a serial number or an associated IP address, providing a more complete picture of the network topology.

Communication links 451-458 represent connections between devices 405-445 that have been identified by network topology service 110 based on event logs. Communication links 451-458 indicate inferred communications between devices. For example, if an event log generated by device 410 indicates that device 405 was the source of a communication (e.g., using IP addresses recorded in the event log), network topology service 110 establishes communication link 451 between device 405 and device 410. These relationships may be represented in metadata, such as the device identifiers in brackets of metadata 320 in FIG. 3.

FIG. 5A-5C illustrates exemplary scenarios 500a, 500b, 500c illustrating inferences made by inference engine 220 of network topology service 110. Scenarios 500a, 500b, 500c are each discussed in turn below.

FIG. 5A illustrates scenario 500a, in which inference engine 220 identifies a device-type based on an event log. Scenario 500a illustrates initial topology 510, inference 501, and updated topology 515. It is noted that initial topology 510 and updated topology 515 may represent only a portion of an overall network topology (e.g., network topology 400 of FIG. 4) for illustrative purposes.

Initial topology 510 includes two devices each with an associated IP address (i.e., 192.168.1.111 and 192.168.1.7). At inference 501, inference engine 220 infers a device type for both devices, in particular that the device type for the device associated with IP address 192.168.1.111 is a workstation. Inference engine 220 may make this inference, for example, based on identifying that a firmware update (or a threshold number of firmware updates) has been sent from IP address 192.168.1.111 (indicating that the IP address is likely associated with a workstation). Inference engine 220 generates updated topology 515 by updating metadata in topology store 250 to indicate that the device is a workstation.

FIG. 5B illustrates scenario 500b, in which inference engine 220 identifies the existence of a new device based on an event log. Scenario 500b illustrates initial topology 520, inference 503, and updated topology 525. It is noted that initial topology 520 and updated topology 525 may represent only a portion of an overall network topology (e.g., network topology 400 of FIG. 4) for illustrative purposes.

Initial topology 520 includes two devices (“192.168.1.111-Workstation” and “192.168.1.7-PLC.” At inference 503, inference engine 220 infers the existence of a new device, “slot 2” indicating that the L84E device in communication with a device in slot 2 via a backplane of a chasses (e.g., backplane 151 of chassis 150 in FIG. 1). Inference engine 220 may make this inference, for example, based on identifying that a communication originated from slot 2. Inference engine 220 generates updated topology 520 by updating metadata in topology store 250 to establish a communication link between the PLC device and a new device at “slot 2.”

FIG. 5C illustrates scenario 500c, in which inference engine 220 identifies the existence of a new device based on an event log. Scenario 500c illustrates initial topology 540, inference 507, and updated topology 545. It is noted that initial topology 540 and updated topology 545 may represent only a portion of an overall network topology (e.g., network topology 400 of FIG. 4) for illustrative purposes.

Inference engine 220 may derive this inference by analyzing event logs from a network adapter (e.g., 192.168.2.14-Network Adapter) that indicate a configuration update was sent to “Slot 0.” If another event log with a similar timestamp from the PLC (192.168.2.6) indicates that the PLC received and applied a configuration update, inference engine 220 can infer that “Slot 0” and “192.168.2.6-PLC” refer to the same device. Inference engine 220 generates updated topology 545 by updating metadata in topology store 250 to establish a communication link between the PLC device and the Network Adapter device, with an indication that the “192.168.2.6-PLC” is the same device as “Slot 0.”

Inference engine 220 may make “fusing” inferences in various other scenarios. For example, if both a first device and a second device establish communication links with a device identified as “Slot 0,” inference engine 220 may analyze event logs to determine that “Slot 0” refers to the same physical device in both cases.

In such a scenario, network topology service 110 may examine timestamped event logs from multiple devices referencing “Slot 0” and check for consistent interactions with the same network adapter or PLC. If the event logs show that both the first and second devices interact with “Slot 0” in a manner that suggests a single physical device (e.g., responding to configuration updates, status queries, or control commands in a unified manner), inference engine 220 may infer that “Slot 0” represents the same device in both and update the network topology accordingly.

FIG. 6 illustrates inference scenario 600 in an implementation. Inference scenario 600 includes event log 610, event log analysis 650, and zone classifications 620, each of which is described in turn below.

Event log 610 may be an event log generated by a workstation (e.g., workstation 122 or 128). Unlike event logs 310 of FIG. 3, which may follow a Syslog format, event log 610 may be formatted differently, such as a Windows Event Viewer log.

Event log 610 represents a status check performed by workstation 122 or 128 running FactoryTalk System Services. The event log provides metadata about devices in the industrial automation environment, including their assigned security zones and IP addresses. Specifically, event log 610 includes a “zone name” field that captures the security zone to which a device belongs and a “harmony path” field that indicates the device's IP address. In addition to these fields, event log 610 contains other relevant metadata such as “Logged Date,” which records the exact timestamp when the event log was generated, “Location,” which identifies the application or service responsible for generating the log on the workstation, and “Username,” which records the credentials of the user associated with the event. Depending on the event type, event log 610 may also include deployment identifiers, model names, and network configuration details.

Event log analysis 650 illustrates analysis of event log 610 performed by network topology service 110 (and in particular, inference engine 220). Inference engine 220 analyzes event log 610 to extract the zonename and IP address from event log (e.g., from the “zoneName” field and “harmonyPath” field, and assign the IP address to a zone accordingly.

Zone classifications 620 represent groupings of IP addresses into security zones (in this case, “Z1—Blend Fill,” “Z2—Safety,” and “Z3—Clean Place.” Inference engine 220 may create these groupings based on many event logs similar to event log 610 identifying various devices. Inference engine 220 stores the IP addresses in association with their security zones in topology store 250. Network topology service 110 may leverage zone classifications 620 to identify potential security threats, as discussed below in relation to steps 807, 809 of process 800.

FIG. 7 illustrates use interface 700 of computing device 120 in an implementation. User interface 700 is generated by U/I module 210 of FIG. 2 and provided computing device 120 for display. It is noted that user interface 700 illustrates one implementation; in other implementations user interfaces on user device 120 may have different arrangements, different elements, or additional or fewer elements.

User interface 700 includes navigation menu 705 and dashboard 750. Navigation menu 705 includes tabs 710, 720, 730. Tab 710 is selectable to illustrate a screen where a user may view a network topology (e.g., network topology 400 of FIG. 4). Tab 720 is selectable by a user for viewing zone classifications, such as zone classifications 620 of FIG. 6. Tab 730 is selectable to view event logs, such as event logs 310 of FIG. 3 or event log 610 of FIG. 6). In the example of FIG. 7, the user has selected tab 710.

Dashboard 750 of user interface 700 is displayed on selection of tab 710. Element 760 represents user actions that a user may initiate in network topology service 110. Element 761 represents an element which a user may select to initiate an update of the network topology. In some implementations, network topology service 110 may initiate process 800 to make inferences about the network topology upon a user selection of element 761. Element 763 represents an element a user may select to detect a security threat based on zone classifications, as discussed below in relation to steps 807, 809 of process 800. Element 770 illustrates a pane displaying a graphical representation of the network topology. U/I module 210 (of FIG. 2) may generate this graphical representation, for example, based on metadata 320 which defines parameters of the network topology.

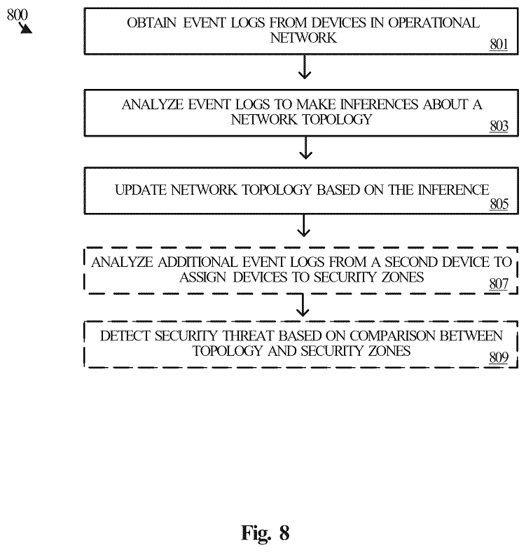

FIG. 8 illustrates network topology generation process performed by network topology service 110, represented by process 800. Process 800 is employed by a computing device, an example of which is provided by computing system 901 of FIG. 9. Process 800 may be implemented in program instructions (software and/or firmware) by one or more processors of the computing device. The program instructions direct the computing device to operate as follows, referring to the steps in FIG. 8.

To begin, network topology service 110 obtains one or more event logs from one or more devices (e.g., PLC 161, network adapter 165, etc.) in operational network 199 (step 801). Event logs (e.g., Syslog messages) generated by devices in operational network 199 are collected and stored in collector 105. Network topology service 110 (an in particular collector interface 230) retrieves the event logs from collector 105. Collector interface 230 may continually monitor collector 105 and retrieve these event logs when they are added for analysis by inference engine 220. In some implementations, the event logs may each be formatted to include a source address of a communication in operational network 199 (e.g., an IP address or a slot number such as “slot 0”) a target address of the communication (e.g., an IP address associated with the device generating the event log) and an event description (e.g., indicating that the communication is a firmware update or a network configuration). It is noted that while the target address is associated with the device generating the event log in this example, in various implementations event logs can be generated by devices sending communications, receiving communications, or performing internal functions. Example event logs are illustrated by event logs 310 of FIG. 3.

Network topology service 110 analyzes the event logs to make an inference about the network topology (step 803). As part of step 803, inference engine 220 of network topology service 110 analyzes the event logs to make inferences about a network topology (e.g., topology 400 of FIG. 4). These inferences may include identifying a device type of a device in the network topology, fusing devices in the network topology, identifying the existence of a new device in the network topology, establishing a new communication link in the network topology, among other examples. In some implementations, the network topology service 110 may employ a threshold-based approach (e.g., making an inference about device-type only after a threshold number of communications support the inference) to reduce false positives and thus improve the accuracy of the network topology.

Network topology service 110 may infer a device type based on the event description contained in the event log. For example, if an event log describes a firmware update being applied to a device, inference engine 220 may determine that the source of the update is a workstation (e.g., workstation 122, 128 of FIG. 1), the typical source for firmware updates. Similarly, if an event log references a network reconfiguration event, the inference engine may deduce that the log-emitting device is a network adapter (e.g., network adapter 145, 165 of FIG. 1)

Additionally, network topology service 110 may infer a new communication link (e.g., communication links 451-458 of FIG. 4) in the network between a device and a second device based at least in part on the source address of the communication. For instance, if an event log generated by a PLC references an incoming communication from an IP address or a slot number, inference engine 220 may establish that a direct communication link exists between the PLC and the identified source device. This provides the discovery of device interactions that may not have been pre-exiting in the network topology.

Various examples of inferences made by inference engine 220 are illustrated and discussed in relation to FIG. 5A-5C. In some cases, inference engine 220 may determine that information contained in the event log is already captured in the network topology (e.g., where the network topology already includes the IP addresses identified in the event log as well as a communication link between these IP addresses). In such cases, inference engine 220 may end the analysis without making further updates to the network topology.

In cases where network topology service 110 makes a new inference based on the event logs, network topology service 110 updates the network topology to incorporate the inference (step 805). To update the network topology, inference engine 220 may update metadata in topology store 250 (as represented by metadata 320 of FIG. 3) to incorporate the inference. For example, where inference engine identifies a device type of a device, inference engine may update the “Type” field of metadata 320 to include the device type (e.g., “1756-EN4TR”).

Network topology service 110 analyzes additional event logs from a second device to assign devices in operational network 199 to security zones (step 807). These additional event logs may be in a different format (e.g. Windows Event Viewer logs, as opposed to Syslog messages of steps 801-805). In some implementations, these additional logs are generated by workstations 122, 128 and may contain security-relevant information, such as authentication events, firewall policy changes, or user access logs. Inference engine 220 processes these additional logs to classify devices into security zones, as represented by security zones 620 of FIG. 6. Once devices are assigned to their respective zones, inference engine 220 updates metadata in topology store 250 to associate security zones with devices in each security zone.

Network topology service 110 detects a security threat based on a comparison between the network topology and the assigned security zones (step 809). Specifically, network topology service 110 identifies security violations by determining whether there is an unauthorized communication link between devices assigned to different security zones. If a communication link (e.g., links 451-458 in FIG. 4) is detected between devices that should not be able to communicate based on their security zone classification, the network topology service 110 flags this as a potential security breach.

Network topology service 110 may perform this security analysis automatically on a scheduled basis or in response to user input (e.g., upon a user selection of element 763 of user interface 700 in FIG. 7). Upon detecting a security threat, network topology service 110 may initiate a remedial action, such as generating an alert and displaying it on computing device 120 (e.g., within user interface 700 of FIG. 7). Additionally, network topology service 110 may log the detected threat for later review by security analysts or trigger automated security enforcement actions, such as blocking unauthorized communications.

FIG. 9 illustrates computing system 901 that is representative of any system or collection of systems in which the various processes, programs, services, and scenarios disclosed herein may be implemented. Examples of computing system 901 include, but are not limited to, desktop and laptop computers, tablet computers, mobile computers, and wearable devices. Examples may also include server computers, web servers, cloud computing platforms, and data center equipment, as well as any other type of physical or virtual server machine, container, and any variation or combination thereof.

Computing system 901 may be implemented as a single apparatus, system, or device or may be implemented in a distributed manner as multiple apparatuses, systems, or devices. Computing system 901 includes, but is not limited to, processing system 902, storage system 903, software 905, communication interface system 907, and user interface system 909. Processing system 902 is operatively coupled with storage system 903, communication interface system 907, and user interface system 909.

Processing system 902 loads and executes software 905 from storage system 903. Software 905 includes and implements topology generation processes 906, which is (are) representative of the application service processes discussed with respect to the preceding figures, such as process 800 of FIG. 8. When executed by processing system 902, software 905 directs processing system 902 to operate as described herein for at least the various processes, operational scenarios, and sequences discussed in the foregoing implementations. Computing system 901 may optionally include additional devices, features, or functionality not discussed for purposes of brevity.

Referring still to FIG. 9, processing system 902 may comprise a microprocessor and other circuitry that retrieves and executes software 905 from storage system 903. Processing system 902 may be implemented within a single processing device but may also be distributed across multiple processing devices or sub-systems that cooperate in executing program instructions. Examples of processing system 902 include general purpose central processing units, graphical processing units, application specific processors, and logic devices, as well as any other type of processing device, combinations, or variations thereof.

Storage system 903 may comprise any computer-readable storage media device readable by processing system 902 and capable of storing software 905. Storage system 903 may include volatile and nonvolatile, removable, and non-removable media implemented in any method or technology for storage of information, such as computer readable software instructions, data structures, program modules, or other data. Examples of storage media include random access memory, read only memory, magnetic disks, optical disks, flash memory, virtual memory and non-virtual memory, magnetic cassettes, magnetic tape, magnetic disk storage or other magnetic storage devices, or any other suitable storage media. In no case is the computer readable storage media a propagated or transitory signal.

In addition to computer-readable storage media, in some implementations storage system 903 may also include computer readable communication media over which at least some of software 905 may be communicated internally or externally. Storage system 903 may be implemented as a single storage device but may also be implemented across multiple storage devices or sub-systems co-located or distributed relative to each other. Storage system 903 may comprise additional elements, such as a controller, capable of communicating with processing system 902 or possibly other systems.

Software 905 (including topology generation processes 906) may be implemented in program instructions and among other functions may, when executed by processing system 902, direct processing system 902 to operate as described with respect to the various operational scenarios, sequences, and processes illustrated herein. For example, software 905 may include program instructions for implementing industrial resource processes as described herein.

In particular, the program instructions may include various components or modules that cooperate or otherwise interact to carry out the various processes and operational scenarios described herein. The various components or modules may be embodied in compiled or interpreted instructions, or in some other variation or combination of instructions. The various components or modules may be executed in a synchronous or asynchronous manner, serially or in parallel, in a single threaded environment or multi-threaded, or in accordance with any other suitable execution paradigm, variation, or combination thereof. Software 905 may include additional processes, programs, or components, such as operating system software, virtualization software, or other application software. Software 905 may also comprise firmware or some other form of machine-readable processing instructions executable by processing system 902.

In general, software 905 may, when loaded into processing system 902 and executed, transform a suitable apparatus, system, or device (of which computing system 901 is representative) overall from a general-purpose computing system into a special-purpose computing system customized to support a network topology service in an optimized manner. Indeed, encoding software 905 on storage system 903 may transform the physical structure of storage system 903. The specific transformation of the physical structure may depend on various factors in different implementations of this description. Examples of such factors may include, but are not limited to, the technology used to implement the storage media of storage system 903 and whether the computer-storage media are characterized as primary or secondary storage, as well as other factors.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import, when used in this application, refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

The phrases “in some embodiments,” “according to some embodiments,” “in the embodiments shown,” “in other embodiments,” “in an implementation,” “in some implementations,” and the like generally mean the particular feature, structure, or characteristic following the phrase is included in at least one implementation of the present technology, and may be included in more than one implementation. In addition, such phrases do not necessarily refer to the same embodiments or different embodiments.

The above Detailed Description of examples of the technology is not intended to be exhaustive or to limit the technology to the precise form disclosed above. While specific examples for the technology are described above for illustrative purposes, various equivalent modifications are possible within the scope of the technology, as those skilled in the relevant art will recognize. For example, while processes or blocks are presented in a given order, alternative implementations may perform routines having steps, or employ systems having blocks, in a different order, and some processes or blocks may be deleted, moved, added, subdivided, combined, and/or modified to provide alternative or subcombinations. Each of these processes or blocks may be implemented in a variety of different ways. Also, while processes or blocks are at times shown as being performed in series, these processes or blocks may instead be performed or implemented in parallel, or may be performed at different times. Further any specific numbers noted herein are only examples: alternative implementations may employ differing values or ranges.

The teachings of the technology provided herein can be applied to other systems, not necessarily the system described above. The elements and acts of the various examples described above can be combined to provide further implementations of the technology. Some alternative implementations of the technology may include not only additional elements to those implementations noted above, but also may include fewer elements.

These and other changes can be made to the technology in light of the above Detailed Description. While the above description describes certain examples of the technology, and describes the best mode contemplated, no matter how detailed the above appears in text, the technology can be practiced in many ways. Details of the system may vary considerably in its specific implementation, while still being encompassed by the technology disclosed herein. As noted above, particular terminology used when describing certain features or aspects of the technology should not be taken to imply that the terminology is being redefined herein to be restricted to any specific characteristics, features, or aspects of the technology with which that terminology is associated. In general, the terms used in the following claims should not be construed to limit the technology to the specific examples disclosed in the specification, unless the above Detailed Description section explicitly defines such terms. Accordingly, the actual scope of the technology encompasses not only the disclosed examples, but also all equivalent ways of practicing or implementing the technology under the claims.

To reduce the number of claims, certain aspects of the technology are presented below in certain claim forms, but the applicant contemplates the various aspects of the technology in any number of claim forms. For example, while only one aspect of the technology is recited as a computer-readable medium claim, other aspects may likewise be embodied as a computer-readable medium claim, or in other forms, such as being embodied in a means-plus-function claim. Any claims intended to be treated under 35 U.S.C. § 112(f) will begin with the words “means for”, but use of the term “for” in any other context is not intended to invoke treatment under 35 U.S.C. § 112(f). Accordingly, the applicant reserves the right to pursue additional claims after filing this application to pursue such additional claim forms, in either this application or in a continuing application.

What is claimed is:

1. A computer-implemented method for industrial network topology generation comprising:
obtaining an event log from a device of a plurality of devices in an industrial automation environment;
analyzing the event log to make an inference about a network topology of the industrial automation environment, wherein the network topology defines:
one or more parameters of the plurality of devices in a network, and
communication links between the devices in the network; and
updating the network topology to incorporate the inference.

2. The computer-implemented method of claim 1, wherein the event log comprises:
a source address of a communication in the network,
a target address of the communication, and
an event description of the communication.

3. The computer-implemented method of claim 2, wherein the device is associated with the target address.

4. The computer-implemented method of claim 2, wherein the analyzing the event log comprises inferring a device type of the device based at least on the event description.

5. The computer-implemented method of claim 2, wherein the analyzing the event log comprises inferring a new communication link, in the network, between the device and a second device of the plurality of devices, based at least in part on the source address of the communication.

6. The computer-implemented method of claim 1, further comprising:
analyzing one or more additional event logs from a second device to assign each of the plurality of devices to a network security zone; and
detecting a security threat based at least in part on a comparison between the network topology and the assigned network security zones.

7. The computer-implemented method of claim 6, wherein the detecting the security threat comprises identifying, within the network topology, a communication link between two devices, from the plurality of devices, assigned to different network security zones.

8. The computer-implemented method of claim 1, further comprising:
generating a graphical representation of the network topology; and
transmitting the graphical representation to a user device for display in a user interface.

9. The computer-implemented method of claim 1, wherein the one or more parameters comprise one or more of: device types associated with the devices, network addresses for the devices, serial numbers of the devices, and chassis slot numbers for the devices.

10. A system comprising:
one or more processors; and
one or more memories operably coupled to the one or more processors and having stored thereon software instructions, that upon execution by the one or more processors, cause the one or more processors to:
obtain an event log from a device of a plurality of devices in an industrial automation environment;
analyze the event log to make an inference about a network topology of the industrial automation environment, wherein the network topology defines:
one or more parameters of the plurality of devices in a network, and
communication links between the devices in the network; and
update the network topology to incorporate the inference.

11. The system of claim 10, wherein the event log comprises:
a source address of a communication in the network,
a target address of the communication, and
an event description of the communication.

12. The system of claim 11, wherein the device is associated with the target address.

13. The system of claim 11, wherein the analyzing the event log comprises inferring a device type of the device based at least on the event description.

14. The system of claim 11, wherein the analyzing the event log comprises inferring a new communication link, in the network, between the device and a second device of the plurality of devices, based at least in part on the source address of the communication.

15. The system of claim 10, wherein the software instructions comprise further instructions that, upon execution by the one or more processors, cause the one or more processors to:
analyze one or more additional event logs from a second device to assign each of the plurality of devices to a network security zone; and
detect a security threat based at least in part on a comparison between the network topology and the assigned network security zones.

16. The system of claim 15, wherein the detecting the security threat comprises identifying, within the network topology, a communication link between two devices, from the plurality of devices, assigned to different network security zones.

17. The system of claim 10, wherein the software instructions comprise further instructions that, upon execution by the one or more processors, cause the one or more processors to:
generate a graphical representation of the network topology; and
transmit the graphical representation to a user device for display.

18. The system of claim 10, wherein the one or more parameters comprise one or more of:
device types associated with the devices, network addresses for the devices, serial numbers of the devices, and chassis slot numbers for the devices.

19. A computer-readable storage media device having program instructions stored thereon, wherein the program instructions, upon execution by one or more processors, cause the one or more processors to:
obtain an event log from a device of a plurality of devices in an industrial automation environment;
analyze the event log to make an inference about a network topology of the industrial automation environment, wherein the network topology defines:
one or more parameters of the plurality of devices in a network, and
communication links between the devices in the network; and
update the network topology to incorporate the inference.

20. The computer-readable storage media device of claim 19, wherein the event log comprises:
a source address of a communication in the network,
a target address of the communication, and
an event description of the communication.
